(19) United States
(12) Patent Application Publication
(10) Pub. No.: US 2002/0189479 A1
(43) Pub. Date: Dec. 19, 2002

(54) Offset press and gapless printing plate

(75) Inventors: Shoichi Furukawa, Hiroshima-ken (JP); Hidetoshi Ohzeki, Hiroshima-ken (JP); Yoshiyuki Yamanoue, Hiroshima-ken (JP)

Correspondence Address: ARMSTRONG,WESTERMAN & HATTORI, LLP, 1725 K STREET, NW., SUITE 1000, WASHINGTON, DC, 20006, US

(73) Assignee: Mitsubishi Heavy Industries, Ltd., Tokyo (JP)

(21) Appl. No.: 10/166,766

(22) Filed: Jun. 12, 2002

(30) Foreign Application Priority Data
Jun. 14, 2001 (JP) 2001-180715
Jun. 21, 2001 (JP) 2001-188272

(51) Int. Cl. B41N 3/00; B41M 5/00

(52) U.S. Cl. 101/465

(57) ABSTRACT

An offset press is equipped with a printer and a writable regenerative platemaker. The printer includes a plate cylinder on which a printing plate is fitted, and a transfer cylinder to which an image on the printing plate is transferred. The regenerative platemaker is formed integrally with the printer and is used to write the image to the printing plate. The printing plate is constructed of a gapless printing plate. The printing plate can be removed from and fitted on the plate cylinder by being moved along the axial direction of the plate cylinder.

### BACKGROUND OF THE INVENTION

(1) Field of the Invention

The present invention relates to an offset press and a gapless printing plate.

(2) Description of the Related Art

FIG. 9 shows the essential part of an ordinary offset press. In the figure, reference numeral 1 denotes the printing unit of the offset press. In the case where the offset press performs multicolor printing, a plurality of printing units 1 are arranged along a traveling path for a web 2.

As shown in FIG. 9, the offset press is provided with a plate cylinder 3 and a blanket cylinder (transfer cylinder) 4. The printing unit 1 is constructed so that printing can be performed on both sides of the web 2. Therefore, the printing unit 1 is provided with upper and lower plate cylinders 3a, 3b and upper and lower blanket cylinders 4a, 4b. In the following description, when there is no need to discriminate between “upper” and “low,” the plate cylinder and the blanket cylinder are represented by reference numerals 3 and 4, respectively.

As shown in FIG. 10, each plate cylinder 3 has a printing plate 5 fitted thereon. The printing plate 5 has an image printed thereon. If ink is supplied to the plate cylinder 3 by an ink supply unit (not shown), the image on the plate cylinder 5 is transferred onto the blanket cylinder 4. The image transferred to the blanket cylinder 4 is printed on the web 2 being traveled.

If the image on the printing plate 5 is printed, the printing plate (oldplate) 5 is removed and a new plating plate with another image printed thereon is fitted on the plate cylinder 3. After the exchange of the old and new plates, the removed printing plate 5 is discarded, because it does not have a new use.

Recently, there has been proposed a regenerative printing plate and platemaker in which an image printed on the printing plate 5 is deleted and a new image is printed again on the printing plate 5. If such a regenerative platemaker is employed, the single printing plate 5 can be repeatedly used many times and therefore costs can be reduced. In addition, the offset press is gentle on the environment.

The regenerative platemaker may be arranged on the side of the offset press (this platemaker is known as a side platemaker). Alternatively, it may be arranged on the travelling path for the web 2 (this platemaker is known as an on-path platemaker). The on-path platemaker is assembled integrally into the printing unit 1. This platemaker is able to print a new image on the printing plate 5 without removing the printing plate 5 from the plate cylinder 3, that is, with the printing plate 5 fitted on the plate cylinder 3. Therefore, in the case of the regenerative on-path platemaker, the frequency of plate exchanges is considerably decreased.

The side platemaker is constructed separately from the printing unit 1. After printing, the printing plate 5 is taken in the platemaker, and a new pattern is written to the printing plate 5 by the side platemaker.

In the on-path platemaker, there is basically no need to perform an exchange of printing plates. However, the printing plate 11 has a limit to the number of reproducing and writing operations. In the case where the printing plate 11 reaches the limit, it is necessary to remove the printing plate 11 from the plate cylinder 3 and fit a new printing plate on the plate cylinder 3.

Now, a brief description will be given of an exchanging operation for the printing plate 5. When exchanging the printing plate 5, as shown in FIG. 10, a clamp (not shown) disposed within a gap 6 in the plate cylinder 3 is first loosened to remove one end 5b of the printing plate 5 from one end of the gap 6. Then, the plate cylinder 3 is rotated in the clockwise direction shown in FIG. 10 to remove the printing plate 5. Finally, the other end 5a of the plate cylinder 5 is disengaged from the other end of the gap 6. In this manner, the plate cylinder 5 is removed from the plate cylinder 3. The operation of fitting the printing plate 5 on the plate cylinder 3 is performed in reversed order.

In the conventional offset press equipped with the aforementioned on-path platemaker, however, various rollers and components are disposed around the plate cylinder and therefore the printing-plate removing and fitting operations are extremely difficult. In addition, the plate exchanging operation is fairly difficult, so that the operation is time-consuming and costly.

### SUMMARY OF THE INVENTION

The present invention has been made in view of the circumstances mentioned above. Accordingly, it is the primary object of the present invention to provide an offset press and a gapless printing plate which are capable of further reducing costs by facilitating the plate exchanging operation even when the offset press is equipped with an on-path platemaker.

To achieve this end, there is provided an offset press having both a printer and a regenerative platemaker. The printer is equipped with a plate cylinder on which a printing plate is fitted, and a transfer cylinder to which an image on the printing plate is transferred. The regenerative platemaker is formed integrally with the printer and is used to write the image to the printing plate. The printing plate is constructed of a gapless printing plate. The printing plate can be removed from and fitted on the plate cylinder by being moved along an axial direction of the plate cylinder.

Therefore, if the gapless printing plate is employed in combination with the on-path platemaker, the printing plate can be repeatedly used without being removed from the printer. This can save both the time required for the plate exchanging operation and the printing plate itself. Thus, there is an advantage that costs can be reduced. In addition, if the printing plate is moved in the axial direction of the plate cylinder, the printing plate can be removed from and fitted onto the plate cylinder. Therefore, even in the case where the plate exchanging operation becomes necessary when the printing plate reaches the regeneration limit, the plate exchanging operation is extremely easy and the operation efficiency is considerably enhanced. Furthermore, the operation time can be considerably shortened. Because of this, costs can be further reduced.

In the offset press of the present invention, the plate cylinder and the transfer cylinder are constructed so that they are respectively provided with drive sources and movable in a radial direction.

With this construction, the circumferential length of the printing plate can be varied. As a result, there is an advantage that the single offset press of the present invention can employ webs of different standards. Compared with the case where two offset presses are required, costs can be considerably reduced. In addition, a lot of space can be saved because only a place for installation of a single offset press is required. Furthermore, costs can be considerably reduced.

It is preferable that the aforementioned transfer cylinder be a gapless transfer cylinder. In this case, a blank between prints can be eliminated, so there is an advantage that loss of paper can be eliminated.

In the offset press of the present invention, the aforementioned gapless printing plate comprises a radially deformable gapless sleeve; a lipophobic coating, formed on the sleeve, which forms non-printing portions of the image; and a lipophilic coating, formed on the lipophobic coating, which forms printing portions of the image.

In this case, the printing plate can be fixed to the plate cylinder by friction force. Therefore, means for fixing the printing plate to the plate cylinder becomes unnecessary. Since the lipophobic coating and hydrophilic coating are formed on the sleeve, there is an advantage that regeneration and writing can be performed easily on the printing plate.

In the offset press of the present invention, the aforementioned sleeve is formed from nickel, and the aforementioned lipophobic coating is formed by depositing aluminum or titanium dioxide on the sleeve.

The aforementioned lipophilic coating is formed by depositing an organic compound or photosensitive resin on the lipophobic coating.

In the offset press of the present invention, the inside diameter of the printing plate is made slightly smaller than the outside diameter of the plate cylinder. In addition, means for injecting a high-pressure fluid from the inside of the plate cylinder toward the outside is provided so that when the printing plate is exchanged, the sleeve is elastically deformed by the high-pressure fluid to perform plate removing and fitting operations.

In this case, the plate cylinder is formed into a taper shape in which one end is smaller in outside diameter than the other end.

In accordance with the present invention, there is provided a gapless printing plate for use in an offset press, comprising: a radially deformable gapless sleeve; a lipophobic coating, formed on the sleeve, which forms non-printing portions of an image; and a lipophilic coating, formed on the lipophobic coating, which forms printing portions of the image.

In the gapless printing plate of the present invention, the aforementioned sleeve is formed from nickel, and the aforementioned lipophobic coating is formed by depositing aluminum or titanium dioxide on the sleeve.

In the gapless printing plate of the present invention, the lipophilic coating is formed by depositing an organic compound or photosensitive resin on the lipophobic coating.

According to the gapless printing plate of the present invention, a gap in the printing plate can be eliminated. Therefore, a blank between prints can be eliminated, and there is an advantage that loss of paper can be eliminated. In addition, if the printing plate is moved in the axial direction of the plate cylinder, the printing plate can be exchanged. Therefore, there is an advantage that the time required for the plate exchanging operation can be considerably shortened. There is another advantage that the plate exchanging operation is extremely easy and the operation efficiency is considerably enhanced. Furthermore, since the sleeve is formed from an elastic material, the printing plate can be fixed easily to the plate cylinder.

Other objects and further features of the present invention will be apparent from the following detailed description when read in conjunction with the accompanying drawings.

### BRIEF DESCRIPTION OF THE DRAWINGS

The present invention will be described in further detail with reference to the accompanying drawings wherein:

FIG. 1 is a schematic diagram showing the essential part of an offset press according to a preferred embodiment of the present invention;

FIG. 2A is a side view of one of the printing units employed in the offset press;

FIG. 2B is a diagram showing different printing plates employed in the offset press;

FIG. 3 is a perspective view showing the gapless printing plate employed in the offset press;

FIG. 4 is an enlarged sectional view of the essential part of the gapless printing plate employed in the offset press;

FIG. 5 is a perspective view used to explain how the gapless printing plate employed in the offset press is removed from or fitted on the plate cylinder of the press offset;

FIG. 6 is a longitudinal sectional view of the plate cylinder employed in the offset press;

FIG. 7 is a cross sectional view of the plate cylinder employed in the offset press;

FIG. 8 is a side view showing the essential part of the offset press;

FIG. 9 is a schematic side view showing the essential part of an ordinary offset press; and

FIG. 10 is an end view of the plate cylinder and the printing plate employed in the ordinary offset press.

### DESCRIPTION OF THE PREFERRED EMBODIMENTS

An offset press according to a preferred embodiment of the present invention will hereinafter be described in detail with reference to the drawings.

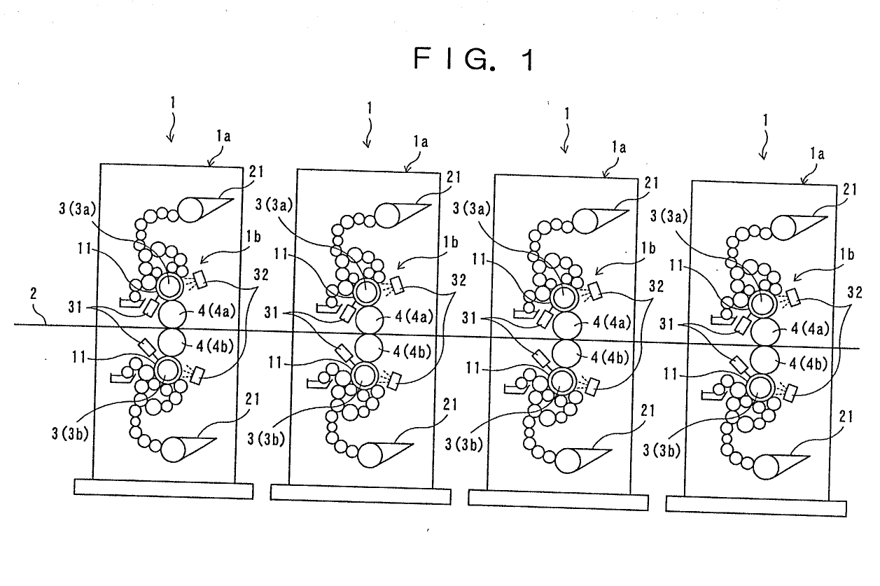

In FIG. 1, reference numeral 1 denotes a printing unit in the offset press and reference numeral 2 denotes a web. The offset press is provided with 4 (four) printing units 1 to make color printing (multicolor printing) possible. Each printing unit 1 is provided with a printer la and a regenerative on-path platemaker (referred to simply as a platemaker) 1b. The printer 1a is provided with upper and lower plate cylinders 3a, 3b and upper and lower blanket cylinders (transfer cylinders) 4a, 4b. In the case where there is no need to discriminate between “upper” and “low,” the plate cylinder and the blanket cylinder are represented by reference numerals 3 and 4, respectively.

Each plate cylinder 3 is equipped with a printing plate 11, which has an image that is to be printed. Ink is supplied to the plate cylinder 3 by an ink supply unit 21. If ink is supplied to the plate cylinder 3, the image on the printing plate 11 is transferred onto the blanket cylinder 4. The image transferred on the blanket cylinder 4 is printed on a web 2 being traveled.

The platemaker 1b is a device for deleting the image on the printing plate 11 after printing and then writing a new image to the printing plate 11. The platemaker 1b is formed integrally with the printer 1a. That is, the platemaker 1b is provided above the printer 1a. Since the platemaker 1b and the printer 1a are provided integrally within the printing unit 1, the size of the printing unit 1 can be reduced.

As shown in FIG. 1, the platemaker 1b is equipped with a plate regenerator 31 for regenerating an image and a plate writer 32 for writing an image.

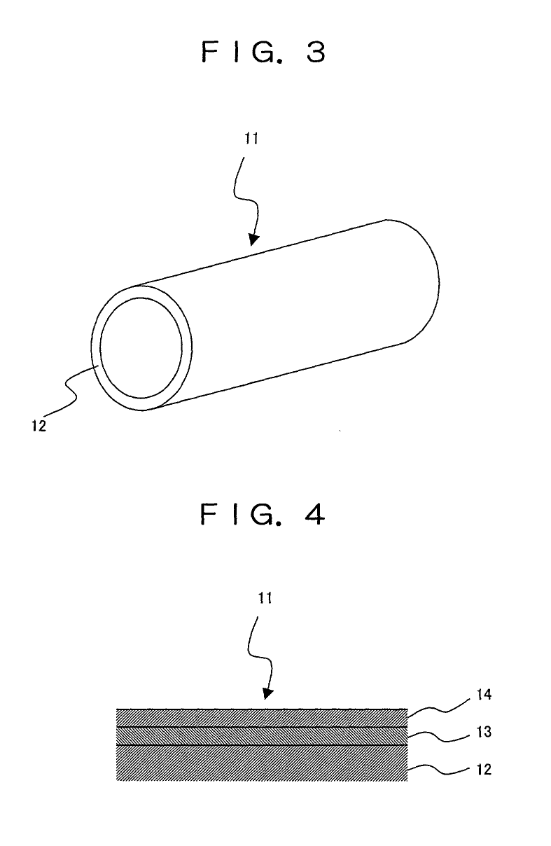

As shown in FIG. 3, the printing plate 11 is constructed as a gapless printing plate. This gapless printing plate 11 is constructed of a gapless sleeve 12. The gapless sleeve 12 has a coating (lipophobic coating) and an organic compound coating (lipophilic coating) formed thereon, as described later.

The blanket cylinder 4 has a gapless rubber plate (not shown) fitted thereon and is constructed as a gapless blanket cylinder. Because the gapless blanket cylinder is well known in the prior art, a description thereof will not be given.

The sleeve 12 is formed from an elastically deformable material such as nickel and is formed into the shape of a cylinder open at both ends. The inside diameter of the sleeve 12 is slightly smaller than the outside diameter of the plate cylinder 3 on which the sleeve 12 is fitted. Therefore, when the sleeve 12 is fitted on the plate cylinder 3, the printing plate 11 is fixed to the plate cylinder 3 by the friction force between the sleeve 12 and the plate cylinder 3.

As shown in FIG. 4, the sleeve 12 has a coating (lipophobic coating) 13 of titanium dioxide (TiO₂) formed thereon. The titanium dioxide coating 13 is formed by depositing a titanium dioxide photocatalyst on the nickel sleeve 12. The titanium dioxide coating 13 functions as non-printing portions to which no ink adheres, when irradiated with active titanium dioxide photocatalyst light.

The titanium dioxide coating 13 can be formed by a chemical vapor deposition (CVD) method, a sputtering method,a sol-gel method, etc. However, the forming method is not limited to these methods. It is also possible to add the second material to the titanium dioxide coating 13 to enhance the strength of the coating 13, to enhance the adhesion between the coating 13 and the sleeve 12, to enhance the activity of the photocatalyst, or to enhance the hydrophilic property and water retentivity of the coating 13. Furthermore, an intervening layer may be provided between the nickel sleeve 12 and the titanium dioxide coating 13 to enhance the adhesion therebetween.

If the titanium dioxide coating 13 is irradiated with the aforementioned active light (i.e., ultraviolet light with a wavelength of 400 nm or less), the titanium dioxide coating 13 will exhibit high lipophobic property (hydrophilic property) by action of the titanium dioxide photocatalyst. In this manner, the exposed portions are formed as non-printing portions to which ink does not adhere. In addition, if the titanium dioxide coating 13 is irradiated with the active light, an organic compound on the photocatalyst surface can be resolved.

An organic compound coating (hydrophilic coating) 14 is formed on the titanium dioxide coating 13. The surface of the organic compound coating 14 exhibits a high hydrophilic property of repelling water but absorbing ink. The organic compound surface also has the property of being resolved by action of the titanium dioxide photocatalyst when irradiated with the aforementioned active light.

Now, a method of forming the organic compound coating 14 will be described. An organic compound, which exhibits hydrophilic property when deposited on the surface of the titanium dioxide coating 13, is dissolved or dispersed into a water or organic liquid. Then, the resultant liquid is deposited on the surface of the titanium dioxide coating 13. In this manner the organic compound coating 14 is formed. Note that after deposition, the organic compound coating 14 may be dried as needed.

A image to be printed is written to the organic compound coating 14 by the plate writer 32. The plate writer 32 is equipped with a write head for irradiating infrared laser light. If infrared laser light is irradiated to the organic compound coating 14, the exposed portions are heated and hardened, and stick fast to the titanium dioxide coating 13.

Thereafter, the unexposed portions are cleaned and removed to develop the hydrophilic non-printing portions on the titanium dioxide coating 13. In this way, an image consisting of printing portions and non-printing portions is formed on the printing plate 11.

The portions not exposed to laser light may be removed by cleaning with a cleaning agent before the start of printing, or by ink tacks after the start of printing.

The plate writer 32 is also able to employ, for example, a write head capable of irradiating the aforementioned active light. If the organic compound coating 14 is exposed to the active light, the exposed portions are dissolved and removed and the hydrophilic non-printing portions in the titanium dioxide coating 13 are developed. In this manner, an image consisting of printing portions and non-printing portions is formed on the printing plate 11.

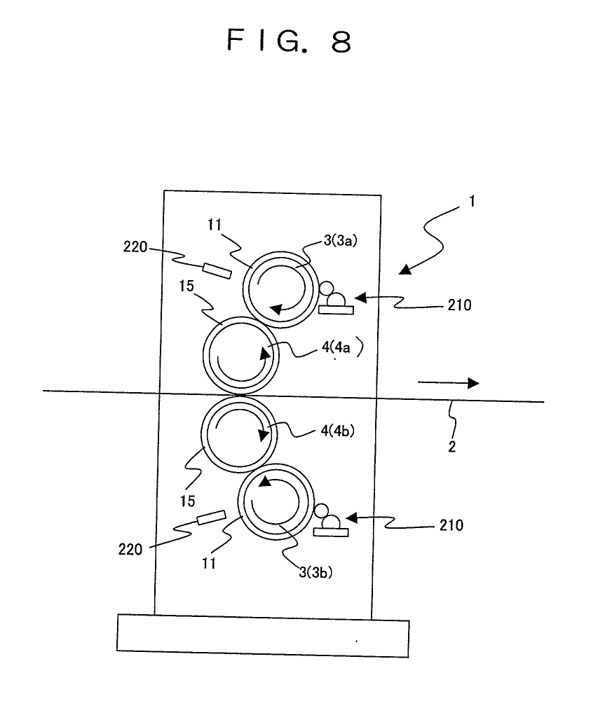

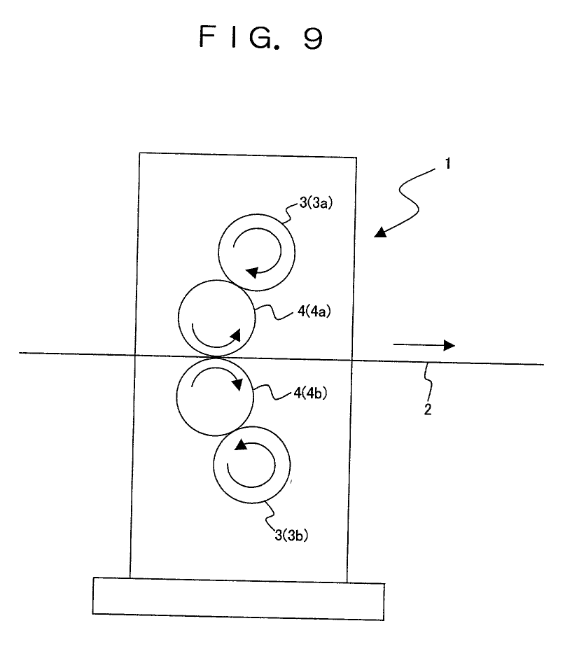

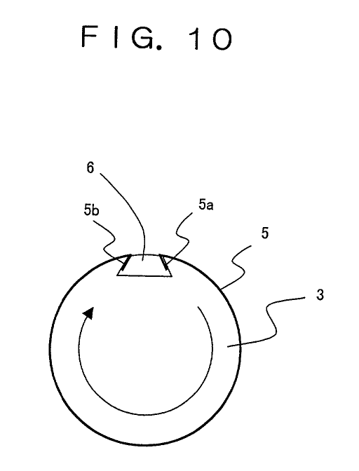

After printing, the ink on the surface of the printing plate 11 is removed with a washer (reference numeral 210 in FIG. 8). Next, the printing plate 11 is irradiated with ultraviolet rays by an ultraviolet ray irradiating device (reference numeral 220 in FIG. 8) to dissolve and remove the printing portions consisting of an organic compound. At the same time, the surface of the titanium dioxide coating 13 is caused to be hydrophilic. Next, by coating the surface of the titanium dioxide coating 13 with an organic compound again, regeneration of the printing plate 11 becomes possible. Note that the washer 210 and the ultraviolet ray irradiating device 220 constitute the plate regenerator 31.

While it has been described that the coating 13 is formed by employing titanium dioxide, the coating 13 may be formed by employing aluminum instead of titanium dioxide. In this case, the lipophilic coating 14 can be formed by depositing a photosensitive resin on the aluminum coating 13.

In the platemaker 1b, a new image to be used in the next printing is written to the printing plate 11 each time printing ends. Therefore, there is no need to exchange the printing plate 11. However, there is a limit to the number of regeneration and write operations with respect to the printing plate 11 (hereinafter referred to as a regeneration limit). When the printing plate 11 reaches the regeneration limit, it is necessary to remove the printing plate 11 from the plate cylinder 3 and fit a new printing plate 11 on the plate cylinder 3.

However, as shown in FIG. 1, various rollers and components are disposed around the plate cylinder 3 and therefore the removing and fitting operations for the printing plate 11 are extremely difficult.

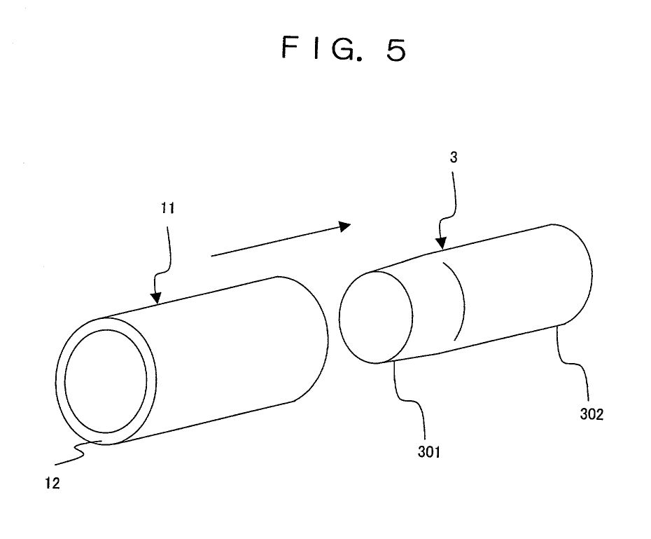

Hence, in the preferred embodiment, the printing plate 11 is removed from or fitted on the plate cylinder 3 by being moved away from or toward the plate cylinder 3 in the axial direction of the plate cylinder 3, as shown in FIG. 5. This enhances the operation efficiency of the plate exchange considerably.

That is, as mentioned above, various rollers and components are disposed around the plate cylinder 3 and therefore the removing and fitting operations for an ordinary printing plate (see reference numeral 5 in FIG. 10) are extremely difficult. However, there is ample space for the plate exchanging operation in the side portion of the printer. Therefore, if the plate removing and fitting operations are performed by moving the printing plate 11 in the axial direction of the plate cylinder 3, the plate exchanging operation can be easily performed. In addition, there is an advantage that the time required for the plate exchanging operation can be considerably shortened. Furthermore, since the plate exchanging operation is performed by moving the printing plate in the axial direction of the plate cylinder, there is an advantage that the plate exchanging operation has no influence on the layout of the rollers and components disposed around the plate cylinder 3.

The outside diameter of the plate cylinder 3 is made slightly greater than the inside diameter of the sleeve 12. Therefore, by utilizing the elastic deformation of the sleeve 12, the printing plate 11 can be fixed to the plate cylinder 3. In addition, as shown in FIG. 5, the plate cylinder 3 is formed into a tape shape in which one end 301 is smaller in diameter than the other end 302. This facilitates the fitting of the printing plate 11 onto the plate cylinder 3.

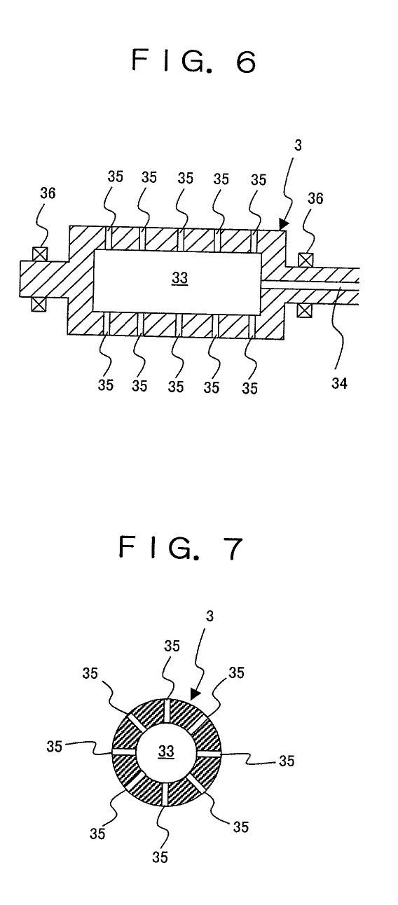

As shown in FIG. 6, the plate cylinder 3 has a cavity 33 interiorly. This cavity 33 is connected to an air pump or high-pressure fluid supply means (not shown) through an air supply passage 34, and air pressurized by this air pump is supplied to the cavity 33 through the air supply passage 34.

As shown in FIGS. 6 and 7, a plurality of air passages 35 are formed in the outer periphery of the plate cylinder 3 so that they are communicated with the cavity 33. These air passages 35 are provided over the entire length of the plate cylinder 3 at predetermined intervals in the axial direction of the plate cylinder 3, as shown in FIG. 6. The air passages 35 are also arranged in a radial manner, as shown in FIG. 7. This arrangement makes it possible to inject high-pressure air evenly at approximately the entire periphery of the plate cylinder 3. Note that the aforementioned air supply passage 34 may be connected to either one end 301 of the plate cylinder 3 or the other end 302. However, considering the operation efficiency of the plate exchange, the other end 302 of the plate cylinder 3 is preferred.

The plate cylinder 3 is rotatably supported on the frame (not shown) of the printer la through bearings 36. One end 301 of the plate cylinder 3 is detachably attached to the printer frame. The operation of exchanging the printing plate 11 is performed with the one end 301 of the plate cylinder 3 removed from the printer frame.

Therefore, when exchanging the printing plate 11, rotation of the plate cylinder 3 is stopped and one end 301 of the plate cylinder 3 is removed from the printer frame (not shown). Then, the air pump (not shown) is operated to supply high-pressure air to the cavity 33 of the plate cylinder 3 through the air supply passages 34. The high-pressure air acts over the entire periphery and entire length of the plate cylinder 3 through the air passages 35.

With action of the high-pressure air, the printing plate (old plate) 11 fitted on the plate cylinder 3 is elastically deformed and the inside diameter increases slightly. This increase in the inside diameter creates a slight gap between the inner peripheral surface of the printing plate 11 and the outer peripheral surface of the plate cylinder 3. In this state, the printing plate (old plate) 11 is removed by being pulled out from one end 301 of the plate cylinder 3.

When fitting the printing plate (new plate) 11 on the plate cylinder 3, the printing plate 11 is fitted on one end 301 of the plate cylinder 3 on which high-pressure air is acting. Since one end 301 of the plate cylinder 3 is slightly smaller in diameter than the other end 302, the printing plate 11 can be fitted on one end 301 of the plate cylinder 3 without being elastically deformed.

If the printing plate 11 is fitted on one end 301 of the plate cylinder 3, the printing plate 11 fitted on the plate cylinder 3 is elastically deformed by action of th ehigh-pressure air. Therefore, by gradually pushing the printing plate 11 in the axial direction of the plate cylinder 3, it can be fitted on the plate cylinder 3. Next, the operation of the air pump is stopped, whereby the printing plate 11 returns to its original shape and is fixed to the plate cylinder 3. That is, because of the friction force between the printing plate 11 and the plate cylinder 3, the printing plate 11 is fixed to the plate cylinder 3.

After the printing plate is fitted on the plate cylinder 3 in the aforementioned manner, one end 301 of the plate cylinder 3 is attached to the printer frame again and the plate exchanging operation ends.

The printer 1a, incidentally, is constructed as a cutoff printer capable of varying the circumferential length of the printing plate.

Now, a brief description will be given of an ordinary offset press. In the offset press, the driving force from a single drive source is usually transmitted to the printing units through shafts (driving shafts). Each plate cylinder and each blanket cylinder are connected together through gears. These gears are driven by the driving force transmitted via the aforementioned shafts. In this way, rotations of the printing units are synchronized accurately with one another.

In such a construction, however, the positions of the center axes of the plate cylinder and blanket cylinder cannot be changed because they are connected via gears. Because of this, the outside diameter of the printing plate is limited to one kind. On the other hand, webs are classified into two kinds of standards: an A-series and a B-series. For this reason, an ordinary offset press can adopt only either of the two standards for webs.

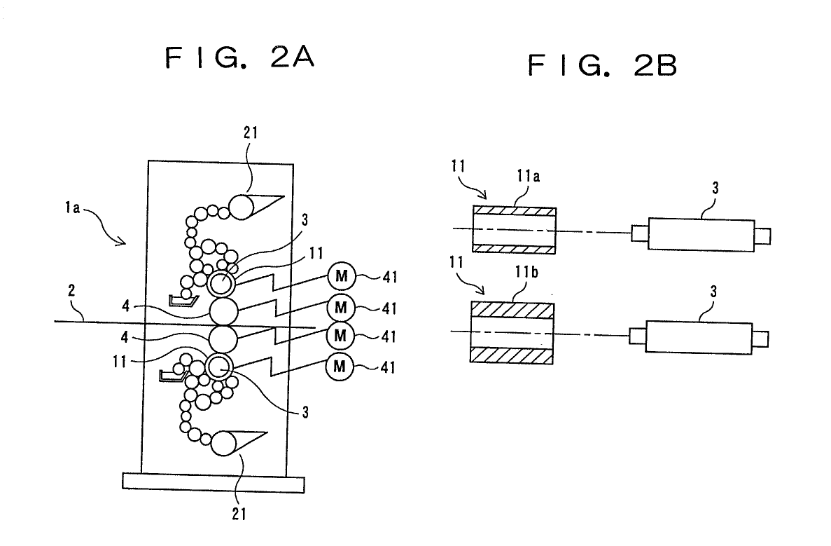

On the other hand, in the printer 1a of the preferred embodiment, the circumferential length of the printing plate 11 is variable so that printing can be performed on both the A-series web and the B-series web. That is, as shown in FIG. 2A, the plate cylinder 3 and the blanket cylinder 4 are provided with motors 41 as drive sources, respectively. Therefore, the plate cylinder 3 and the blanket cylinder 4 can be individually driven. Although details are not shown, the plate cylinder 3 and the blanket cylinder 4 are constructed so that they are each movable in the radial direction (vertical direction shown in FIG. 2) by ball-screw mechanisms, for example.

As shown in FIG. 2B, printing plate has a first printing plate 11a whose circumferential length corresponds to the A-series and a second printing plate 11b whose circumferential length corresponds to the B-series. The first and second printing plates 11a, 11b differ in outside diameter but the same in inside diameter. Thus, they can be fitted on the same plate cylinder 3.

Such a construction enables a single offset press to meet a plurality of standards for webs. For instance, in the case where the second printing plate 11b for the B-series is used after printing is performed by the first printing plate 11a for the A-series, the plate cylinder 3 and the blanket cylinder 4 are moved to a predetermined position for the B-series before the second printing plate 11b is fitted on the plate cylinder 3.

If the second printing plate 11b is fitted on the plate cylinder 3, the plate cylinder 3 and the blanket cylinder 4 are driven by the respective motors 41 and perform printing. Note that the speed of each motor 41 is controlled on the basis of a control signal from a controller (not shown).

The offset press of the preferred embodiment has the following advantages, because it is constructed as mentioned above:

According to the offset press of the preferred embodiment, the writable gapless printing plate 11 is employed in combination with the platemaker 1b. Therefore, the printing plate 11 can be repeatedly used without being removed from the printer 1a. This can save both the time required for the plate exchanging operation and the printing plate 11 itself. Thus, there is an advantage that costs can be reduced.

If the printing plate 11 is moved in the axial direction of the plate cylinder 3, the printing plate 11 can be removed from and fitted onto the plate cylinder 3. Therefore, even in the case where the plate exchanging operation becomes necessary when the printing plate 11 reaches the regeneration limit, the plate exchanging operation is extremely easy and the operation efficiency is considerably enhanced. In addition, the operation time can be considerably shortened. Because of this, costs can be further reduced.

Since the platemaker 1b and the printer 1a are provided integrally within the printing unit 1, the size of the printing unit 1 can be reduced.

The plate cylinder 3 and the blanket cylinder (transfer cylinder) 4 are respectively provided with motors (drive sources) 41 and movable in the radial or vertical direction, so there is an advantage that the single offset press of the preferred embodiment can employ webs of different standards. Compared with the case where two offset presses are required, costs can be considerably reduced. In addition, a lot of space can be saved because only a place for installation of a single offset press is required.

A combination of the gapless printing plate 11 and the gapless blanket cylinder 4 can eliminate a blank between prints, so there is an advantage that loss of paper can be eliminated. Furthermore, since the gapless printing plate 11 is formed by the elastically deformable gapless sleeve 12, the printing plate 11 can be fixed to the plate cylinder 3 by friction force, and means for fixing the printing plate 11 to the plate cylinder 3 becomes unnecessary.

The titanium dioxide coating (lipophobic coating) 13 forming non-printing portions is formed on the sleeve 12, and the organic compound coating (hydrophilic coating) 14 forming printing portions is formed on the titanium dioxide coating (lipophobic coating) 13. With this arrangement, there is an advantage that regeneration and writing can be performed easily on the printing plate 11.

In the conventional offset press, gaps (see reference numeral 6 in FIG. 10) are present in the plate cylinder 3 and the blanket cylinder 4. Because of this, if the plate cylinder 3 and the blanket cylinder 4 make one revolution, the two gaps abut each other and therefore great load fluctuations take place in the plate cylinder 3 and the blanket cylinder 4. On the other hand, the offset press of the present invention has no gap in the plate cylinder 3 and the blanket cylinder 4 and is therefore able to eliminate such great load fluctuations.

The sleeve 12 is formed from an elastic member (e.g., nickel). Therefore, by elastically deforming the sleeve 12 when fitting the printing plate 11 on the plate cylinder 3, the printing plate 11 can be fixed to the plate cylinder 3. That is, the outside diameter of the plate cylinder 3 is made slightly greater than the inside diameter of the sleeve 12. When fitting the printing plate 11 on the plate cylinder 3, the sleeve 12 is elastically deformed so that the inside diameter thereof is increased. After the fitting of the printing plate 11, the sleeve 12 is returned to its original shape. In this manner, the printing plate 11 can be fixed to the plate cylinder 3. Because of this, there is no need to provide means for fixing the printing plate 11 to the plate cylinder 3, and a reduction in the weight of the plate cylinder 3 can be achieved. In addition, by reducing the weight of the plate cylinder 3, the force of inertia of the plate cylinder 3 can be reduced during operation of the offset press and therefore there is an advantage that accuracy of rotation is enhanced.

The plate cylinder 3 is tapered so that the diameter of one end 301 becomes smaller than that of the other end 302. This facilitates the fitting of the printing plate 11 onto the plate cylinder 3, so that there is an advantage that the operation efficiency of the plate exchange is further enhanced.

In the offset press of the present invention, the printing plate 11 has the titanium dioxide photocatalyst coating 13 on the surface thereof. Therefore, if the ink on the plate surface is removed by the washer 210 after printing and then the plate surface is irradiated with ultraviolet rays emitted from the ultraviolet-ray irradiating device 220, the printing plate 11 can be regenerated. Thus, an exchange of plates becomes unnecessary and there is an advantage that a reduction in the preparation time, an enhancement in the production efficiency, and a reduction in the printing cost can be achieved.

While the present invention has been described with reference to the preferred embodiment thereof, the invention is not to be limited to the details given herein, but may be modified within the scope of the invention hereinafter claimed. For example, the inside diameter of the sleeve 12 can be made slightly greater than the outside diameter of the plate cylinder 3. In this case, an exchange of plates becomes simpler and therefore the operation efficiency is considerably enhanced. In this case, means for fixing the printing plate 11 to the plate cylinder 3 becomes necessary. However, the printing plate 11 can be easily fixed to the plate cylinder 3 by generating negative pressure within the cavity 33 shown in FIGS. 6 and 7.

While it has been described that high-pressure air is supplied by the air pump (high-pressure fluid supply means), other fluids may be employed. The number and position of air passages 35 may be changed as long as they do not interfere with the plate exchanging operation.

What is claimed is:

1. An offset press comprising:
a printer comprising
a plate cylinder on which a printing plate is fitted, and
a transfer cylinder to which an image on said printing plate is transferred; and
a regenerative platemaker, formed integrally with said printer, for writing said image to said printing plate;
wherein said printing plate is constructed of a gapless printing plate; and
wherein said printing plate can be removed from and fitted on said plate cylinder by being moved along an axial direction of said plate cylinder.

2. The offset press as set forth in claim 1, wherein said plate cylinder and said transfer cylinder are constructed so that they are respectively provided with drive sources and movable in a radial direction.

3. The offset press as set forth in claim 2, wherein said transfer cylinder comprises a gapless transfer cylinder.

4. The offset press as set forth in claim 3, wherein said gapless printing plate comprises
a radially deformable gapless sleeve,
a lipophobic coating, formed on said sleeve, which forms non-printing portions of said image, and
a lipophilic coating, formed on said lipophobic coating, which forms printing portions of said image.

5. The offset press as set forth in claim 4, wherein
said sleeve is formed from nickel, and
said lipophobic coating is formed by depositing aluminum or titanium dioxide on said sleeve.

6. The offset press as set forth in claim 5, wherein said lipophilic coating is formed by depositing an organic compound or photosensitive resin on said lipophobic coating.

7. The offset press as set forth in claim 6, wherein
the inside diameter of said printing plate is made slightly smaller than the outside diameter of said plate cylinder, and
means for injecting a high-pressure fluid from the inside of said plate cylinder toward the outside is provided so that when said printing plate is exchanged, said sleeve is elastically deformed by said high-pressure fluid to perform plate removing and fitting operations.

8. The offset press as set forth in claim 7, wherein said plate cylinder is formed into a taper shape in which one end is smaller in outside diameter than the other end.

9. The offset press as set forth in claim 6, wherein said plate cylinder is formed into a taper shape in which one end is smaller in outside diameter than the other end.

10. The offset press as set forth in claim 5,wherein the inside diameter of said printing plate is made slightly smaller than the outside diameter of said plate cylinder, and
means for injecting a high-pressure fluid from the inside of said plate cylinder toward the outside is provided so that when said printing plate is exchanged, said sleeve is elastically deformed by said high-pressure fluid to perform plate removing and fitting operations.

11. The offset press as set forth in claim 10, wherein said plate cylinder is formed into a taper shape in which one end is smaller in outside diameter than the other end.

12. The offset press as set forth in claim 5, wherein said plate cylinder is formed into a taper shape in which one end is smaller in outside diameter than the other end.

13. The offset press as set forth in claim 4, wherein said lipophilic coating is formed by depositing an organic compound or photosensitive resin on said lipophobic coating.

14. The offset press as set forth in claim 13, wherein the inside diameter of said printing plate is made slightly smaller than the outside diameter of said plate cylinder, and
means for injecting a high-pressure fluid from the inside of said plate cylinder toward the outside is provided so that when said printing plate is exchanged, said sleeve is elastically deformed by said high-pressure fluid to perform plate removing and fitting operations.

15. The offset press as set forth in claim 14, wherein said plate cylinder is formed into a taper shape in which one end is smaller in outside diameter than the other end.

16. The offset press as set forth in claim 13, wherein said plate cylinder is formed into a taper shape in which one end is smaller in outside diameter than the other end.

17. The offset press as set forth in claim 4, wherein
the inside diameter of said printing plate is made slightly smaller than the outside diameter of said plate cylinder, and
means for injecting a high-pressure fluid from the inside of said plate cylinder toward the outside is provided so that when said printing plate is exchanged, said sleeve is elastically deformed by said high-pressure fluid to perform plate removing and fitting operations.

18. The offset press as set forth in claim 17, wherein said plate cylinder is formed into a taper shape in which one end is smaller in outside diameter than the other end.

19. The offset press as set forth in claim 4, wherein said plate cylinder is formed into a taper shape in which one end is smaller in outside diameter than the other end.

20. The offset press as set forth in claim 2, wherein said gapless printing plate comprises
a radially deformable gapless sleeve,
a lipophobic coating, formed on said sleeve, which forms non-printing portions of said image, and
a lipophilic coating, formed on said lipophobic coating, which forms printing portions of said image.

21. The offset press as set forth in claim 20, wherein
said sleeve is formed from nickel, and
said lipophobic coating is formed by depositing aluminum or titanium dioxide on said sleeve.

22. The offset press as set forth in claim 21, wherein said lipophilic coating is formed by depositing an organic compound or photosensitive resin on said lipophobic coating.

23. The offset press as set forth in claim 22, wherein
the inside diameter of said printing plate is made slightly smaller than the outside diameter of said plate cylinder, and
means for injecting a high-pressure fluid from the inside of said plate cylinder toward the outside is provided so that when said printing plate is exchanged, said sleeve is elastically deformed by said high-pressure fluid to perform plate removing and fitting operations.

24. The offset press as set forth in claim 23, wherein said plate cylinder is formed into a taper shape in which one end is smaller in outside diameter than the other end.

25. The offset press as set forth in claim 22, wherein said plate cylinder is formed into a taper shape in which one end is smaller in outside diameter than the other end.

26. The offset press as set forth in claim 21, wherein
the inside diameter of said printing plate is made slightly smaller than the outside diameter of said plate cylinder, and
means for injecting a high-pressure fluid from the inside of said plate cylinder toward the outside is provided so that when said printing plate is exchanged, said sleeve is elastically deformed by said high-pressure fluid to perform plate removing and fitting operations.

27. The offset press as set forth in claim 26, wherein said plate cylinder is formed into a taper shape in which one end is smaller in outside diameter than the other end.

28. The offset press as set forth in claim 21, wherein said plate cylinder is formed into a taper shape in which one end is smaller in outside diameter than the other end.

29. The offset press as set forth in claim 20, wherein said lipophilic coating is formed by depositing an organic compound or photosensitive resin on said lipophobic coating.

30. The offset press as set forth in claim 29, wherein
the inside diameter of said printing plate is made slightly smaller than the outside diameter of said plate cylinder, and
means for injecting a high-pressure fluid from the inside of said plate cylinder toward the outside is provided so that when said printing plate is exchanged, said sleeve is elastically deformed by said high-pressure fluid to perform plate removing and fitting operations.

31. The offset press as set forth in claim 30, wherein said plate cylinder is formed into a taper shape in which one end is smaller in outside diameter than the other end.

32. The offset press as set forth in claim 29, wherein said plate cylinder is formed into a taper shape in which one end is smaller in outside diameter than the other end.

33. The offset press as set forth in claim 20, wherein the inside diameter of said printing plate is made slightly smaller than the outside diameter of said plate cylinder, and
means for injecting a high-pressure fluid from the inside of said plate cylinder toward the outside is provided so that when said printing plate is exchanged, said sleeve is elastically deformed by said high-pressure fluid to perform plate removing and fitting operations.

34. The offset press as set forth in claim 33, wherein said plate cylinder is formed into a taper shape in which one end is smaller in outside diameter than the other end.

35. The offset press as set forth in claim 20, wherein said plate cylinder is formed into a taper shape in which one end is smaller in outside diameter than the other end.

36. The offset press as set forth in claim 1, wherein said transfer cylinder comprises a gapless transfer cylinder.

37. The offset press as set forth in claim 36, wherein said gapless printing plate comprises
a radially deformable gapless sleeve,
a lipophobic coating, formed on said sleeve, which forms non-printing portions of said image, and
a lipophilic coating, formed on said lipophobic coating, which forms printing portions of said image.

38. The offset press as set forth in claim 37, wherein
said sleeve is formed from nickel, and
said lipophobic coating is formed by depositing aluminum or titanium dioxide on said sleeve.

39. The offset press as set forth in claim 38, wherein said lipophilic coating is formed by depositing an organic compound or photosensitive resin on said lipophobic coating.

40. The offset press as set forth in claim 39, wherein
the inside diameter of said printing plate is made slightly smaller than the outside diameter of said plate cylinder, and
means for injecting a high-pressure fluid from the inside of said plate cylinder toward the outside is provided so that when said printing plate is exchanged, said sleeve is elastically deformed by said high-pressure fluid to perform plate removing and fitting operations.

41. The offset press as set forth in claim 40, wherein said plate cylinder is formed into a taper shape in which one end is smaller in outside diameter than the other end.

42. The offset press as set forth in claim 39, wherein said plate cylinder is formed into a taper shape in which one end is smaller in outside diameter than the other end.

43. The offset press as set forth in claim 38, wherein
the inside diameter of said printing plate is made slightly smaller than the outside diameter of said plate cylinder, and
means for injecting a high-pressure fluid from the inside of said plate cylinder toward the outside is provided so that when said printing plate is exchanged, said sleeve is elastically deformed by said high-pressure fluid to perform plate removing and fitting operations.

44. The offset press as set forth in claim 43, wherein said plate cylinder is formed into a taper shape in which one end is smaller in outside diameter than the other end.

45. The offset press as set forth in claim 38, wherein said plate cylinder is formed into a taper shape in which one end is smaller in outside diameter than the other end.

46. The offset press as set forth in claim 37, wherein said lipophilic coating is formed by depositing an organic compound or photosensitive resin on said lipophobic coating.

47. The offset press as set forth in claim 46, wherein
the inside diameter of said printing plate is made slightly smaller than the outside diameter of said plate cylinder, and
means for injecting a high-pressure fluid from the inside of said plate cylinder toward the outside is provided so that when said printing plate is exchanged, said sleeve is elastically deformed by said high-pressure fluid to perform plate removing and fitting operations.

48. The offset press as set forth in claim 47, wherein said plate cylinder is formed into a taper shape in which one end is smaller in outside diameter than the other end.

49. The offset press as set forth in claim 46, wherein said plate cylinder is formed into a taper shape in which one end is smaller in outside diameter than the other end.

50. The offset press as set forth in claim 37, wherein
the inside diameter of said printing plate is made slightly smaller than the outside diameter of said plate cylinder, and
means for injecting a high-pressure fluid from the inside of said plate cylinder toward the outside is provided so that when said printing plate is exchanged, said sleeve is elastically deformed by said high-pressure fluid to perform plate removing and fitting operations.

51. The offset press as set forth in claim 50, wherein said plate cylinder is formed into a taper shape in which one end is smaller in outside diameter than the other end.

52. The offset press as set forth in claim 37, wherein said plate cylinder is formed into a taper shape in which one end is smaller in outside diameter than the other end.

53. The offset press as set forth in claim 1, wherein said gapless printing plate comprises
a radially deformable gapless sleeve,
a lipophobic coating, formed on said sleeve, which forms non-printing portions of said image, and
a lipophilic coating, formed on said lipophobic coating, which forms printing portions of said image.

54. The offset press as set forth in claim 53, wherein
said sleeve is formed from nickel, and
said lipophobic coating is formed by depositing aluminum or titanium dioxide on said sleeve.

55. The offset press as set forth in claim 54, wherein said lipophilic coating is formed by depositing an organic compound or photosensitive resin on said lipophobic coating.

56. The offset press as set forth in claim 55, wherein
the inside diameter of said printing plate is made slightly smaller than the outside diameter of said plate cylinder, and
means for injecting a high-pressure fluid from the inside of said plate cylinder toward the outside is provided so that when said printing plate is exchanged, said sleeve is elastically deformed by said high-pressure fluid to perform plate removing and fitting operations.

57. The offset press as set forth in claim 56, wherein said plate cylinder is formed into a taper shape in which one end is smaller in outside diameter than the other end.

58. The offset press as set forth in claim 55, wherein said plate cylinder is formed into a taper shape in which one end is smaller in outside diameter than the other end.

59. The offset press as set forth in claim 54, wherein
the inside diameter of said printing plate is made slightly smaller than the outside diameter of said plate cylinder, and
means for injecting a high-pressure fluid from the inside of said plate cylinder toward the outside is provided so that when said printing plate is exchanged, said sleeve is elastically deformed by said high-pressure fluid to perform plate removing and fitting operations.

60. The offset press as set forth in claim 59, wherein said plate cylinder is formed into a taper shape in which one end is smaller in outside diameter than the other end.

61. The offset press as set forth in claim 54, wherein said plate cylinder is formed into a taper shape in which one end is smaller in outside diameter than the other end.

62. The offset press as set forth in claim 53, wherein said lipophilic coating is formed by depositing an organic compound or photosensitive resin on said lipophobic coating.

63. The offset press as set forth in claim 62, wherein
the inside diameter of said printing plate is made slightly smaller than the outside diameter of said plate cylinder, and
means for injecting a high-pressure fluid from the inside of said plate cylinder toward the outside is provided so that when said printing plate is exchanged, said sleeve is elastically deformed by said high-pressure fluid to perform plate removing and fitting operations.

64. The offset press as set forth in claim 63, wherein said plate cylinder is formed into a taper shape in which one end is smaller in outside diameter than the other end.

65. The offset press as set forth in claim 62, wherein said plate cylinder is formed into a taper shape in which one end is smaller in outside diameter than the other end.

66. The offset press as set forth in claim 53, wherein
the inside diameter of said printing plate is made slightly smaller than the outside diameter of said plate cylinder, and
means for injecting a high-pressure fluid from the inside of said plate cylinder toward the outside is provided so that when said printing plate is exchanged, said sleeve is elastically deformed by said high-pressure fluid to perform plate removing and fitting operations.

67. The offset press as set forth in claim 66, wherein said plate cylinder is formed into a taper shape in which one end is smaller in outside diameter than the other end.

68. The offset press as set forth in claim 53, wherein said plate cylinder is formed into a taper shape in which one end is smaller in outside diameter than the other end.

69. A gapless printing plate for use in an offset press, comprising:
a radially deformable gapless sleeve
a lipophobic coating, formed on said sleeve, which forms non-printing portions of an image; and
a lipophilic coating, formed on said lipophobic coating, which forms printing portions of said image.

70. The gapless printing plate as set forth in claim 69, wherein
said sleeve is formed from nickel, and
said lipophobic coating is formed by depositing aluminum or titanium dioxide on said sleeve.

71. The gapless printing plate as set forth in claim 70, wherein said lipophilic coating is formed by depositing an organic compound or photosensitive resin on said lipophobic coating.

72. The gapless printing plate as set forth in claim 69, wherein said lipophilic coating is formed by depositing an organic compound or photosensitive resin on said lipophobic coating.

73. An offset press comprising:
a plate cylinder on which a printing plate is fitted; and
a transfer cylinder to which an image on said printing plate is transferred;
wherein said gapless printing plate comprises
a radially deformable gapless sleeve,
a lipophobic coating, formed on said sleeve, which forms non-printing portions of said image, and
a lipophilic coating, formed on said lipophobic coating, which forms printing portions of said image.

74. The offset press as set forth in claim 73, wherein
the inside diameter of said printing plate is made slightly smaller than the outside diameter of said plate cylinder, and
means for injecting a high-pressure fluid from the inside of said plate cylinder toward the outside is provided so that when said printing plate is exchanged, said sleeve is elastically deformed by said high-pressure fluid to perform plate removing and fitting operations.

75. The offset press as set forth in claim 74, wherein said plate cylinder is formed into a taper shape in which one end is smaller in outside diameter than the other end.

76. The offset press as set forth in claim 75, wherein said transfer cylinder is constructed of a gapless transfer cylinder.

77. The offset press as set forth in claim 74, wherein said transfer cylinder is constructed of a gapless transfer cylinder.

78. The offset press as set forth in claim 73, wherein said transfer cylinder is constructed of a gapless transfer cylinder.
